(19) United States
(12) Patent Application Publication
(10) Pub. No.: US 2024/0285988 A1
(43) Pub. Date: Aug. 29, 2024

(54) Compressed Gas Fire Extinguisher Apparatus and Methods

(71) Applicant: Ronald E. Thames, Sharpsburg, GA (US)

(72) Inventor: Ronald E. Thames, Sharpsburg, GA (US)

(21) Appl. No.: 18/586,193

(22) Filed: Feb. 23, 2024

Related U.S. Application Data
(60) Provisional application No. 63/448,149, filed on Feb. 24, 2023.

(51) Int. Cl. A62C 13/72; A62C 13/76

(52) U.S. Cl. CPC A62C 13/72; A62C 13/76

(57) ABSTRACT

A fire extinguisher includes a first tank containing liquid foam concentrate and a second tank coupled therewith that contains compressed air. A first manifold located inside the first tank defines a cavity having at least one opening for receiving the compressed air and at least one opening for receiving the liquid foam concentrate. A second manifold is coupled with the second tank. A Schrader valve is coupled with the second manifold and is selectively actuatable to introduce compressed air into the second tank. A first conduit extends between the first tank and the second manifold of the second tank and provides fluid communication between the first and second tanks. A second conduit is in fluid communication with the first tank and a nozzle. The nozzle is selectively actuatable to discharge a foam formed when compressed air and foam concentrate solution pass through the cavity of the first manifold.

### CROSS REFERENCE TO RELATED APPLICATION

The present application claims the benefit of U.S. Provisional Patent Application No. 63/448,149, filed Feb. 24, 2023, the entire disclosure of which is hereby incorporated by reference herein.

### TECHNICAL FIELD

Embodiments of the present invention generally relate to the field of fire extinguishers and methods of operation thereof. More particularly, embodiments of the present invention relate to fire extinguishers that employ an external compressed gas source to aerate and expand a foam concentrate solution and produce foam that is dispensed for firefighting purposes.

### BACKGROUND

In the field of fire extinguishers, it is known to employ compressed gases, such as compressed air and/or nitrogen, to generate and propel a foam that is used to fight fires. This type of system is sometimes referred to as a compressed air foam system (“CAFS”). In this regard, a CAFS fire extinguisher typically includes a container of “foam solution,” or “premix,” which is a solution of water and foam concentrate. Compressed gas is supplied to the container to aerate and expand the foam solution, thereby producing foam that can be dispensed for firefighting purposes. Various compositions of foam concentrate are known for this purpose, including synthetic concentrates, which may be fluorine free or fluorinated, and protein-based concentrates.

### SUMMARY

In one embodiment, the present invention provides a fire extinguisher. The fire extinguisher comprises a first tank defining a first interior volume containing a foam concentrate solution and a second tank coupled with the first tank. The second tank defines a second interior volume separate from the first interior volume, and the second interior volume contains compressed air. A first manifold is disposed inside the first tank, and the first manifold defines a first cavity. The first cavity has at least one opening for receiving the compressed air and at least one opening for receiving the foam concentrate solution. A second manifold is coupled with the second tank, and the second manifold defines a second cavity in fluid communication with the second interior volume. A Schrader valve is coupled with the second manifold and is selectively actuatable to introduce compressed air into the second cavity and the second interior volume. Further, a first conduit extends between the first tank and the second manifold of the second tank. The first conduit provides fluid communication between the first interior volume and the second interior volume. The fire extinguisher also comprises a second conduit in fluid communication with the first interior volume and a nozzle. The nozzle is selectively actuatable to discharge a foam formed from compressed air and foam concentrate solution passing through the first cavity of the first manifold.

In accordance with another embodiment, the present invention provides a method of operating a fire extinguisher. The method comprises providing a fire extinguisher comprising a tank assembly, wherein the tank assembly defines a first interior volume and a second interior volume. The tank assembly further comprises a first manifold disposed within the first interior volume. The first manifold defines a first cavity, and the first cavity defines a plurality of openings to the first interior volume. The tank assembly also comprises a Schrader valve in fluid communication with the second interior volume and a first conduit having a first end and a second end. The first end of the conduit is in fluid communication with the first interior volume and the second end of the conduit is in fluid communication with the second interior volume. Also, the tank assembly comprises a nozzle in fluid communication with the first interior volume via a second conduit. Next, the method comprises filling the first interior volume with a foam concentrate solution. The method further comprises filling the second interior volume with compressed air via the Schrader valve to a pressure between about 100 PSI and 150 PSI. Additionally, the method comprises actuating the nozzle to dispense a foam formed by the foam concentrate solution and the compressed air.

According to a still further embodiment, the present invention provides a fire extinguisher. The fire extinguisher comprises a frame, a first tank welded to the frame, and a second tank welded to the frame. The first tank contains foam concentrate solution and the second tank contains compressed air. Also, the fire extinguisher comprises a first manifold disposed inside the first tank. The first manifold defines a first cavity through which foam concentrate solution and compressed air pass in response to actuation of a nozzle that is in fluid communication with the first tank. The fire extinguisher also comprises a second manifold coupled with the second tank. The second manifold comprises a housing defining a second cavity in fluid communication with an interior volume of the second tank, and the second cavity further comprises a first port, a second port, and a third port. A first valve is in fluid communication with the first port. The first valve comprises a seat disposed in the second cavity, a moveable valve stem, and a valve member disposed in the second cavity and selectively engageable with the seat in response to movement of the valve stem. A second valve is in fluid communication with the second port, and a third valve is in fluid communication with the third port.

### BRIEF DESCRIPTION OF THE DRAWINGS

Having thus described some example embodiments in general terms, reference will now be made to the accompanying drawings, which are not necessarily drawn to scale, and wherein:

FIG. 1 is a schematic elevation view of a fire extinguisher in accordance with an embodiment of the present invention;

FIG. 2 is a top plan view of the fire extinguisher of FIG. 1;

FIG. 3 is a cross-sectional view of the foam concentrate solution tank of the fire extinguisher of FIG. 1, taken along the line 3-3 in FIG. 2;

FIG. 4 is a cross-sectional view of the compressed gas tank of the fire extinguisher of FIG. 1, taken along the line 4-4 in FIG. 2;

FIG. 5 is an elevation view of the manifold of the compressed gas tank of the fire extinguisher of FIG. 1, wherein several valves and the pressure gauge are not shown;

FIG. 6 is a flow diagram illustrating steps of a method of operating a fire extinguisher in accordance with another embodiment of the present invention;

FIG. 7 is a schematic elevation view of a fire extinguisher in accordance with another embodiment of the present invention; and

FIG. 8 is a schematic elevation view of a fire extinguisher in accordance with yet another embodiment of the present invention.

Repeat use of reference characters in the present specification and drawings is intended to represent same or analogous features or elements of embodiments of the present invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, terms referring to a direction or a position relative to the orientation of a fire extinguisher, such as but not limited to “vertical,” “horizontal,” “upper,” “lower,” “front,” or “rear,” refer to directions and relative positions with respect to the fire extinguisher's orientation in its normal intended operation, as indicated in the Figures herein. Thus, for instance, the terms “vertical” and “upper” refer to the vertical direction and relative upper position in the perspectives of the Figures and should be understood in that context, even with respect to an apparatus that may be disposed in a different orientation. The term “substantially,” as used herein, should be interpreted as “nearly” or “close to”, such as to account for design and manufacturing tolerances of the apparatus.

Moreover, the term “or” as used in this application and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. The phrase “at least one of A and B” is satisfied by any of A alone, B alone, A and B alone, and A and B with others. The phrase “one of A and B” is satisfied by A, whether or not also in the presence of B, and by B, whether or not also in the presence of A.

Embodiments of the present invention relate to improved fire extinguishers and methods of operating fire extinguishers. In various embodiments, a fire extinguisher includes two tanks that are welded together and/or each to a common tank frame. A first tank receives a foam concentrate solution and a second tank receives a compressed gas, such as compressed air. In one embodiment, when the tanks are charged, the compressed gas is fed to the first tank from the second tank via external tubing that is connected with the interiors of each tank. Also, in one example, the first tank has an internal manifold with an expansion chamber in which the compressed gas and foam concentrate solution mix to generate foam. The foam is then expelled via actuation of a nozzle attached to the first tank. The compressed gas in the second tank can be filled, for example, to pressures between about 100 and about 300 PSI, and in some embodiments to pressures between about 100 and about 150 PSI. In one embodiment, the second tank is filled to about 125 PSI. In various embodiments, the second tank also includes a Schrader valve extending between the tank's interior and an area exterior of the tank, with the Schrader valve actuatable from the tank's exterior to selectively access the tank's interior so that the tank can be recharged using smaller air compressors, such as those available to individual consumers. Further, the second tank includes a pressure relief valve to prevent overfilling in some embodiments. In various embodiments, by providing the compressed gas tank separately from the foam concentrate solution tank, it is possible to completely fill the first tank with foam concentrate solution (as opposed to filling a single tank partially with foam concentrate solution and partially with compressed gas). This allows a greater volume of foam to be produced for firefighting purposes. Additionally, it makes refilling the fire extinguisher with compressed gas easier and more simple, in that there is no longer a risk of error in refilling a single concentrate and gas tank with an improper ratio of concentrate to compressed gas. In certain embodiments, the second tank contains enough compressed gas to exhaust the supply of foam concentrate solution in the first tank during use of the system without having to refill the compressed gas tank. Additional aspects of embodiments of the present invention are described in greater detail below.

Although one or more preferred embodiments are discussed herein in the context of compressed air foam fire extinguishers, those of skill in the art will appreciate that the present invention is not so limited. In particular, it is contemplated that embodiments of the present invention may be used with any suitable source of compressed gas, such as but not limited to nitrogen, carbon dioxide, and compressed air. Also, fire extinguishers in accordance with embodiments of the present invention are not limited to foam extinguishers, but also include chemical and/or water extinguishers. Although certain embodiments are depicted with a foam expansion manifold disposed inside the foam concentrate solution tank, in other embodiments a foam expansion manifold may be disposed external to the fire extinguisher tank housing and/or the foam concentrate solution tank. Further, it is contemplated that various embodiments may employ any suitable number of compressed gas and/or foam concentrate solution tanks.

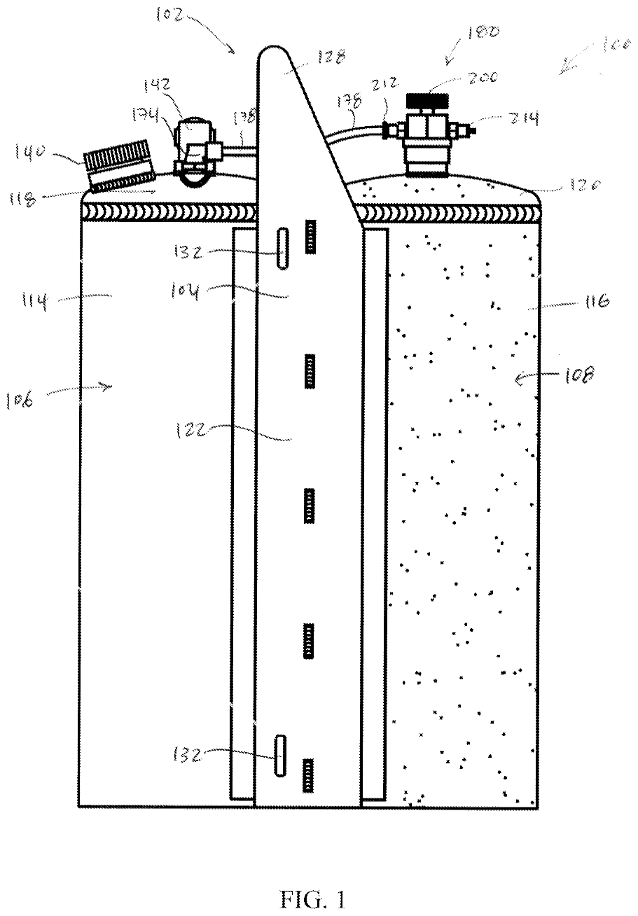

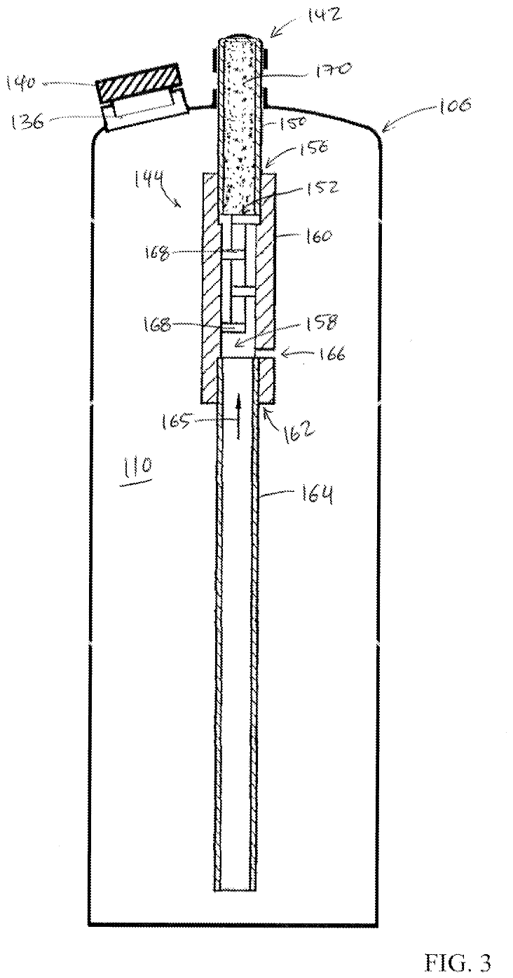

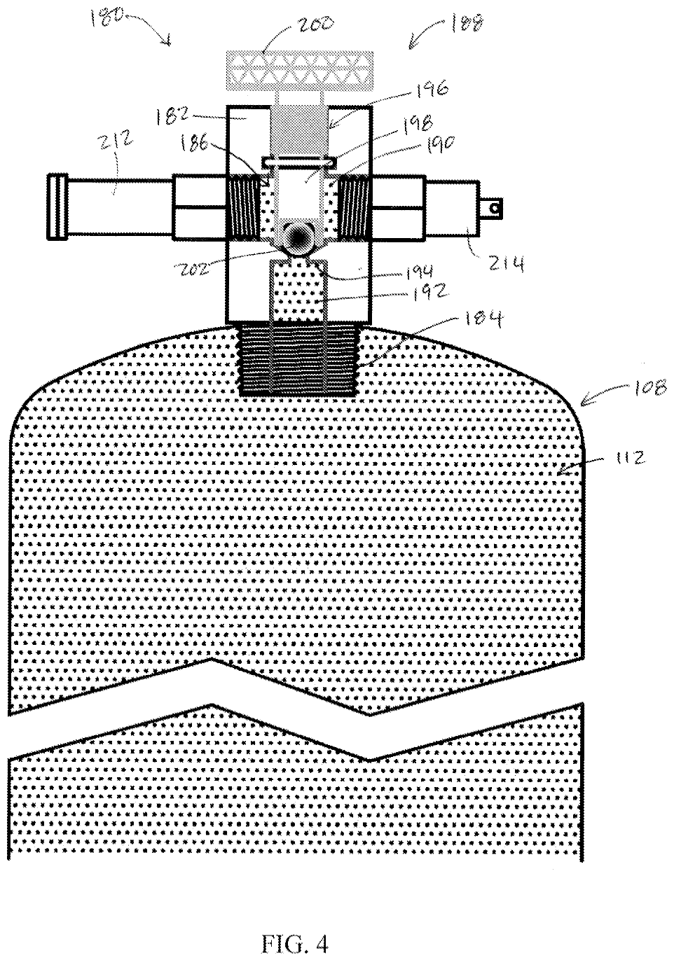

Turning now to the Figures, FIGS. 1-5 show various views of a fire extinguisher 100 in accordance with an embodiment of the present invention. Fire extinguisher 100 in this embodiment comprises a tank assembly 102 comprising a tank frame 104 and two tanks 106, 108. Tank 106 defines an interior volume 110 (FIG. 3), and tank 108 defines an interior volume 112 (FIG. 4). In this embodiment, interior volume 110 is separate from interior volume 112. However, interior volume 110 is in fluid communication with interior volume 112, as described in greater detail below.

In this embodiment, tanks 106, 108 are generally cylindrical in shape, and each respectively defines a cylindrical body portion 114, 116 to which dome-shaped upper portions 118, 120 respectively are attached (e.g., by welding). In other embodiments, of course, tanks 106, 108 may define any suitable shape and may be unitary in construction. Also, in some embodiments described in more detail below, tanks 106, 108 need not be arranged side-by-side, instead, e.g., so that one tank is internal to and, e.g., concentric with, the other tank. Further, tank frame 102 may comprise a single housing with two or more separate interior volumes (whether stacked, arranged side-by-side, or disposed in another arrangement), and separate tanks 106, 108 need not be used.

As shown in FIG. 1, in some embodiments, tanks 106, 108 are formed of different materials, but in other embodiments tanks 106, 108 may be formed from the same material. In this embodiment, tank 106 is formed from aluminum and tank 108 is formed from stainless steel. Additionally, in the illustrated embodiment, tanks 106, 108 may each have a capacity of about three U.S. gallons. In other embodiments, though, tanks 106, 108 of any size may be used. For instance, in some embodiments, tanks 106, 108 may have a capacity between about one U.S. gallon and ten U.S. gallons.

As noted, in the illustrated embodiment, tanks 106, 108 are coupled together via tank frame 104. In other embodiments, though, tanks 106, 108 may be coupled to one another by any suitable method (e.g., by straps that surround and secure the tanks to each other, etc.) and tank frame 104 need not be provided. Further, the coupling can form the tank bodies integrally with each other, e.g., in their initial production or through subsequent joining of separate tanks, e.g., by welding, so that the tanks cannot be separated other than by damaging the structure. Where provided, tank frame 104 preferably defines a structure that retains tanks 106, 108 in a desired position relative to one another and that allows a user to carry tanks 106, 108 together. In preferred embodiments, tank frame 104 may be formed from any suitable high-strength and low-weight material, such as a metal material like aluminum or stainless steel or a polymer material.

More particularly, in this embodiment tank, frame 104 comprises outer walls 122, 124 that are disposed in facing opposition to one another and at least one inner wall 126 that extends between outer walls 122, 124. Inner wall 126 may be generally planar and oriented perpendicularly to generally planar outer walls 122, 124, as shown, although this is not required. In general, outer walls 122, 124 and inner wall 126 are rectangular in shape and define a height roughly equal to the height of tanks 106, 108. However, in this embodiment, outer walls 122, 124 each have a tapered upper end 128 that extends above tanks 106, 108 by a distance that is suitable for a user to grasp a handle 130 that extends between upper ends 128. Additionally, outer walls 122, 124 may each define a plurality of slots 132 sized to receive straps or the like, such as straps connected to a backpack. Thus, a user also may carry fire extinguisher 100 like a backpack or otherwise using straps.

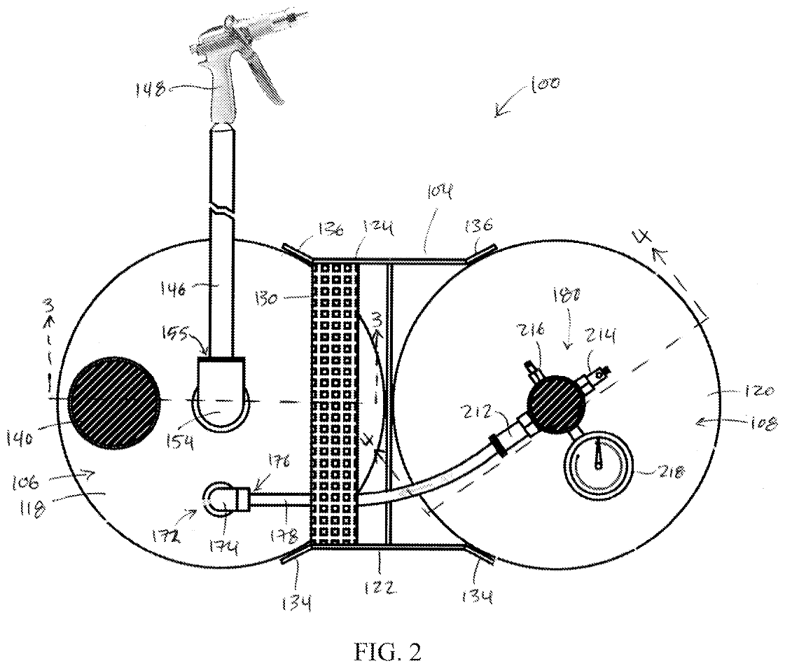

In one embodiment, tanks 106, 108 are coupled to tank frame 104 by welding. For example, each outer wall 122, 124 may define (or be coupled with) a pair of generally planar flanges 134, 136, respectively that are disposed at an acute angle relative to each generally planar outer wall 122, 124. In one embodiment, flanges 134, 136 can be formed by bending portions of outer walls 122, 124. As shown, the angle of flanges 134, 136 relative to outer walls 122, 124 is defined so that the flanges 134, 136 engage the sides of tanks 106, 108 when tanks 106, 108 are disposed against inner wall 126. Flanges 134, 136 therefore provide a surface that can be welded and/or glued to the exteriors of tanks 106, 108. In other embodiments, however, tanks 106, 108 can be coupled with tank frame 104 by any suitable method, including straps, fasteners, or the like. Additionally, although the embodiment shown in FIGS. 1-2 depicts tanks 106, 108 as oriented vertically, this is not required in all embodiments. Instead, in some embodiments, tanks 106, 108 may be oriented horizontally or at a non-zero angle to each other or to frame 104.

In a preferred embodiment, fire extinguisher 100 is a foam-type extinguisher employing compressed air to generate foam and as an expellant for the foam. Accordingly, interior volume 110 of tank 106 can be filled with a foam concentrate solution, and the interior volume 112 of tank 108 can be filled with compressed air. Because volume 112 of tank 108 is discrete from interior volume 110 of tank 106, interior volume 110 can be completely filled with foam concentrate solution. This is advantageous because it enables more foam to be generated for firefighting purposes than it otherwise would be if interior volume 110 of tank 106 were filled with both compressed gas and foam concentrate solution.

In this regard, and with reference to FIGS. 1-3, tank 106 defines a fill opening 138 that is selectively closeable, e.g., by a threaded cap 140. As those of skill in the art will appreciate, water and foam concentrate can be introduced to interior volume 110 in an appropriate or desired ratio prior to use of fire extinguisher 100. Those of skill in the art can select a suitable foam concentrate and foam concentrate solution based on the intended application for fire extinguisher 100, the type of fire to be extinguished, and the type of concentrate selected, among other things. One example of suitable foam concentrates includes the FIREBULL® line of foam concentrates offered by Enforcer One, LLC of Peachtree City, Georgia.

Additionally, in this embodiment, tank 106 comprises a fitting 142 extending from upper portion 118 into interior volume 110. Preferably, fitting 142 comprises a length of pipe, tubing, or the like that extends between a manifold 144 disposed in interior volume 110 and a conduit 146 that carries expanded foam to a nozzle 148 coupled with a distal end of conduit 146. In an embodiment, conduit 146 can be a ½″, ⅜″, or ¼″ hard rubber hose suitable for use at pressures up to 300 PSI, though conduit 146 can be formed of any suitable material in other embodiments. Here, fitting 142 includes a straight portion 150 that defines an inlet 152 and an elbow 154 that defines an outlet 155. An outlet 156 of manifold 144 is connected to inlet 152 of fitting 142, and conduit 146 is connected at its proximal end to outlet 155 of fitting 142. Fitting 142 may be formed of any material suitable for use with firefighting chemicals (including stainless steel and aluminum), and in one embodiment fitting 142 is formed of brass.

Manifold 144 operates to generate foam from compressed gas and foam concentrate solution that are introduced into manifold 144 in a manner that is understood by those of skill in the art. In general, manifold 144 defines at least one cavity 158 within a housing 160. As noted above, manifold 144 defines an outlet 156 that is coupled with inlet 152 of fitting 142 and also defines a plurality of other openings, as needed or desired. For instance, manifold 144 defines an inlet opening 162 that receives one end of a tube 164. Tube 164 extends proximate the bottom of tank 106 and, as explained in more detail below, conducts foam concentrate solution into manifold 144 in the direction of arrow 165 in FIG. 3. Also, manifold 144 defines one or more gas inlets 166 through which compressed gas from tank 108 can enter manifold 144 and aerate and/or expand the foam concentrate solution to produce foam.

In various embodiments, the size of manifold 144 relative to tank 106 and interior volume 110 can vary depending on user requirements, the type and consistency of foam to be generated, etc. It should be understood that, in certain embodiments, manifold 144 is smaller than the manifold 144 depicted in FIG. 3 and can be positioned closer to the upper portion 118 of tank 106. In certain embodiments, at least one of the one or more gas inlets 166 can be about 1″ from the top of interior volume 110. It is also contemplated that, in some embodiments, an additional conduit is fluidly coupled between fitting 172 and manifold 144 to introduce compressed gas directly into manifold 144 at the same time that compressed gas enters interior volume 110, even where the level of foam concentrate solution initially is above the level of the one or more gas inlets 166.

In various embodiments, those of skill in the art can select a manifold 144 suitable for receiving compressed gas and foam concentrate solution and generating foam for firefighting purposes. In the illustrated embodiment, however, manifold 144 is analogous to one of the valves described in U.S. Pat. No. 9,403,290, entitled “Valves for Generating a Foam Material,” issued Aug. 2, 2016, the entire contents of which are hereby incorporated by reference herein for all purposes. As described in the '290 patent, air and foam concentrate solution enter manifold 144 and pass from inlet 162 to outlet 156, in doing so passing through angularly-offset apertures defined in a plurality of barriers 168 that are disposed in cavity 158. This agitates the combined fluid and generates foam 170. In other embodiments, any of the other valves described in the '290 patent may be used with embodiments of the present invention.

As best seen in FIGS. 1-2, tank 106 also comprises a fitting 172 that allows transfer of compressed gas from interior volume 112 of tank 108 into interior volume 110. In particular, one end of fitting 172 is disposed in interior volume 110, and the opposite end terminates in an elbow 174 disposed on upper portion 118. Fitting 172 may be formed of the same material as fitting 142, described above. Further, an outlet 176 of fitting 172 is fluidly coupled with one end of a conduit 178, and the opposite end of conduit 178 is fluidly coupled with a manifold 180 of tank 108. In one embodiment, conduit 178 is the same as or analogous to conduit 146, described above.

More particularly, and with reference to FIG. 4, in one embodiment, manifold 180 can be a valve manifold and comprises a manifold housing 182 that is releasably connected with upper portion 120 of tank 108. In this regard, housing 182 defines a depending threaded portion 184 that engages with a correspondingly-threaded opening defined in tank 108. Also, manifold 180 defines a cavity 186 within housing 182 that is in fluid communication with second interior volume 112.

Although not required in all embodiments, in this embodiment manifold 180 comprises a stop valve 188. Specifically, here, cavity 186 comprises an upper cavity 190 and a lower cavity 192 separated by a valve seat 194. Lower cavity 192 extends between valve seat 194 and interior volume 112. A first port 196 is defined in housing 182 and is in fluid communication with upper cavity 190. First port 196 in this embodiment is threaded and engages with a correspondingly-threaded portion of a valve stem 198. Exterior of housing 182, valve stem 198 terminates at a knob or thumb screw 200, and interior of housing 182, valve stem 198 terminates in a valve member 202. In various embodiments, valve member 202 can be of any size and shape to provide sealing engagement with valve seat 194. Thus, in some embodiments, valve member 202 can be a plug, disk, or the like. In the illustrated embodiment, valve member 202 is a ball disposed in a socket defined at one end of valve stem 198. A user may rotate thumb screw 200 about the longitudinal axis of valve stem 198 to move valve stem 198 and valve member 202 downward or upward relative to housing 182, thereby causing valve member to respectively come into and out of sealing engagement with valve seat 194.

Accordingly, in this embodiment, compressed gas can only be added to or removed from tank 108 when stop valve 188 is opened (i.e., when thumb screw 200 is rotated to cause valve member 202 to move out of engagement with valve seat 194). Once tank 108 is filled with compressed gas, stop valve 188 can be closed (i.e., by rotating thumb screw 200 to cause valve member 202 to move into engagement with valve seat 194) until a user desires to use fire extinguisher 100. In this way, compressed gas cannot exit through any of the valves coupled with manifold 180 when fire extinguisher 100 is not being used, thus maintaining the air pressure in tank 108 over time.

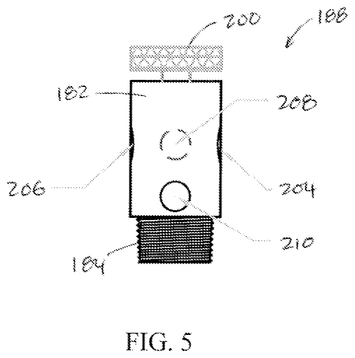

Next, manifold housing 182 in this embodiment defines a plurality of other ports, not all of which are required in all embodiments. As best seen in FIG. 5, for example, manifold housing 182 defines a second port 204, a third port 206, a fourth port 208, and a fifth port 210. Ports 204, 206, 208, and 210 in this embodiment define openings extending between cavity 186 and the exterior of housing 182 that can receive various valves and/or gauges, as needed or desired for the operation of fire extinguisher 100. Although these ports may employ or receive any type of connection in various embodiments, in the illustrated embodiment ports 204, 206, 208, and 210 define threaded openings that receive correspondingly-threaded valves and/or gauges. The type of thread provided will depend on the type of valve and/or gauge that is needed or desired, but in one embodiment, ports 204 and 206 define ¼″ National Pipe Thread (“NPT”) threads, and ports 208 and 210 define ⅛″ NPT threads.

As shown in FIGS. 1, 2, and 4, a one-way check valve 212 is threadably connected at its proximal end with port 206. At its distal end, check valve 212 is connected with the end of conduit 178 (not shown in FIG. 4) that is opposite the end of conduit 178 connected with fitting 172. Thereby, and assuming that valve 188 is open, compressed gas may travel through check valve 212, into conduit 178, through fitting 172, and into interior volume 110 of tank 106 provided the difference in pressure between the compressed gas and the interior volume 110 is larger than the check valve's closing bias force. One-way check valve 212 blocks gas flow in the opposite direction, as is well-understood in the art of check valves, thereby preventing compressed gas from flowing back into interior volume 112. Valve 212 may be formed of brass in one embodiment.

With continued reference to these Figures, a safety, or pressure-relief, valve 214 is connected at its proximal end with port 204 in this embodiment. As is well understood, pressure-relief valve 214 is normally closed but will open when the pressure in cavity 186 exceeds a predetermined pressure to allow compressed gas to escape and to prevent over-filling. When the pressure in cavity 186 falls below the predetermined pressure, pressure-relief valve 214 will close again. Those of ordinary skill in the art are familiar with and can select a suitable pressure-relief valve 214 for use with fire extinguisher 100. The particular valve selected will depend, among other things, on the pressure to which interior volume 112 will be filled in use.

Additionally, as shown in FIG. 2, a Schrader valve 216 is threadably connected at is proximal end with port 208. Schrader valve 216 also is a normally-closed valve similar or identical to the Schrader valves that are included on some vehicle tires, in some embodiments. When a source of compressed air is connected to Schrader valve 216, thereby mechanically forcing the Schrader valve open, as should be understood, Schrader valve 216 is open to allow the air to pass through cavity 186 into interior volume 112 (again assuming that stop valve 188 is in the open position). Assuming that the source of compressed air is at a pressure that exceeds the pressure of air in interior volume 112, air will continue to pass through Schrader valve 216 until interior volume 112 reaches the user's desired pressure or until the pressure in interior volume 112 exceeds the predetermined pressure that causes pressure-relief valve 214 to open.

Advantageously, by including Schrader valve 216 on tank 108 manifold 180, the user of tank 108 is provided with many options for filling tank 108 to the desired pressure. For instance, tank 108 can be filled via Schrader valve 216 using a consumer-accessible air compressor, such as a portable air compressor used to fill vehicle tires or an air compressor located at a gas station or convenience store. Additionally, tank 108 can be filled via Schrader valve 216 via a hand or battery-powered pump in some embodiments or via an air compressor located on a truck, such as a fire truck.

Moreover, by including a tank 108 for compressed gas that is similar in volume to the tank 106 containing foam concentrate solution, in various embodiments the foam concentrate solution in tank 106 may be fully exhausted during use of fire extinguisher 100 without having to refill tank 108 with compressed gas or to connect another source of compressed air to tank 108. In other words, and although tank 108 need not be identical in volume to tank 106 in various embodiments, in one preferred embodiment, the volume of compressed gas that tank 108 can hold is sufficient to exhaust the foam concentrate solution in tank 106 in producing foam 170 during a single use of fire extinguisher 100. For instance, if tank 106 has a capacity of three (3) U.S. Gallons, up to sixty (60) U.S. Gallons of foam 170 can be produced without having to change compressed gas sources or to refill tank 108.

This is in contrast to existing systems, some of which employ smaller bottles (e.g., 3-12 cubic feet) of compressed gas that are connected to a hose in fluid communication with the interior of a tank containing foam concentrate solution. In such systems, when the compressed gas in the smaller bottles is spent, the user must disconnect the spent bottle and connect a new, full bottle to continue using the fire extinguisher. In addition to the time it takes to do this, the user must carry or otherwise have access to multiple full bottles of compressed gas. This is also an improvement over foam fire extinguishers that have a single interior volume containing both compressed gas and foam concentrate solution.

Finally, and also as shown in FIG. 2, in this embodiment a pressure gauge 218 is fluidly coupled with cavity 186 in manifold 180. More specifically, pressure gauge 218 can define a threaded portion that corresponds to and engages with the threads in port 210, as described above. Assuming that stop valve 188 is in the open position, pressure gauge 218 will be in fluid communication with and will indicate the pressure of the compressed gas in interior volume 112. Those of skill in the art can provide a suitable digital or analog pressure gauge 218 for this purpose.

In use of fire extinguisher 100, a user first may charge the fire extinguisher 100. For instance, the user can add water and foam concentrate in an appropriate ratio to tank 106 via fill opening 138 to form foam concentrate solution. As described above, in various embodiments, interior volume 110 of tank 106 can be filled to capacity with foam concentrate solution. Next, the user can connect Schrader valve 216 of tank 108 to a suitable source of compressed gas, such as a consumer-accessible air compressor or pump, and turn screw 200 to open stop valve 188. Thereby, the user can fill interior volume 112 with the compressed gas (e.g., air) to a desired pressure (e.g., 125 PSI). Conduit 178 and the unused volume of interior volume 110 (if any) also will be pressurized during this process. Once complete, the user disconnects the source of compressed gas from Schrader valve 216. If the fire extinguisher is to be stored for later use, the user may rotate screw 200 to move valve 188 to a closed position, as described above.

When the fire extinguisher is placed into service, the user first opens valve 188 by turning screw 200, if valve 188 is not already open. The user then can aim nozzle 148 at the fire to be suppressed and actuate the nozzle 148 (e.g., by squeezing a trigger or pulling a handle) to dispense foam 170. More specifically, when nozzle 148 is actuated, the pressure at the nozzle's outlet is lower than the pressure in interior volumes 110, 112. As a result, compressed gas from interior volume 112 passes through conduit 178 and forces foam concentrate solution into tube 164 where it passes to manifold 144. At approximately the same time, compressed gas also enters manifold 144 via the one or more gas inlets 166. (This will occur once the level of foam concentrate solution in interior volume 110 is below the level of at least one of the one or more gas inlets 166. In an embodiment where the level of foam concentrate solution in interior volume 110 initially is above the level of at least one of the one or more gas inlets 166 and where the compressed gas does not have a direct connection to manifold 144, the composition and/or consistency of foam generated and sprayed may be different for the first few seconds, until the compressed gas is able to enter manifold 144.) As described above, the compressed gas aerates and expands the foam concentrate solution as they pass through manifold 144, resulting in foam 170. Foam 170 then passes through fitting 142, into conduit 146, and through nozzle 148, from which it is discharged toward the fire.

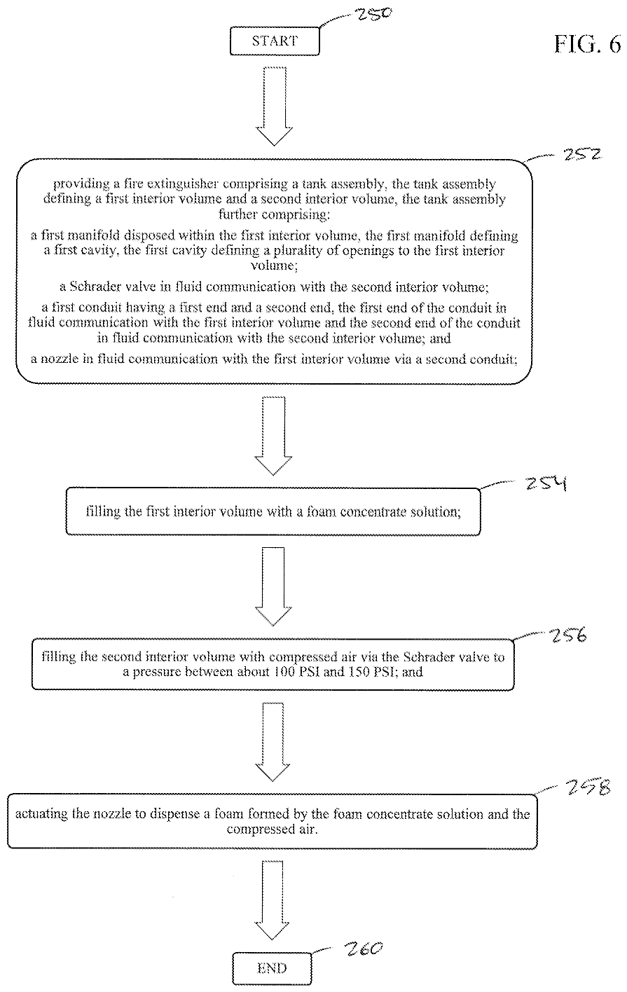

Embodiments of the present invention also provide methods for operating a fire extinguisher. An example of a method performed in accordance with one embodiment of the present invention is provided below with reference to the flowchart shown in FIG. 6. At operation 250, the process starts. At operation 252, provided is a fire extinguisher comprising a tank assembly. The tank assembly defines a first interior volume and a second interior volume, and the tank assembly further comprises a first manifold disposed within the first interior volume. The first manifold defines a first cavity, and the first cavity defines a plurality of openings to the first interior volume. The tank assembly also comprises a Schrader valve in fluid communication with the second interior volume and a first conduit having a first end and a second end. The first end of the conduit is in fluid communication with the first interior volume and the second end of the conduit is in fluid communication with the second interior volume. The tank assembly further comprises a nozzle in fluid communication with the first interior volume via a second conduit. Next, at operation 254, the first interior volume is filled with a foam concentrate solution. Then, at operation 256, the second interior volume is filled with compressed air via the Schrader valve to a pressure between about 100 PSI and 150 PSI. At operation 258, the nozzle is actuated to dispense a foam formed by the foam concentrate solution and the compressed air. Finally, at operation 260, the process ends.

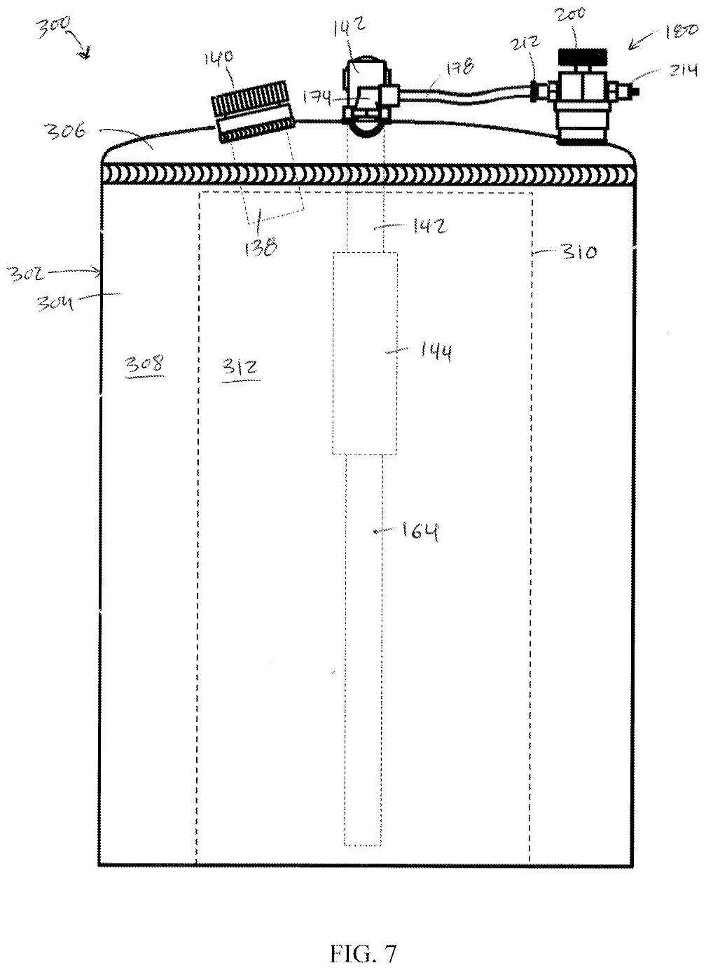

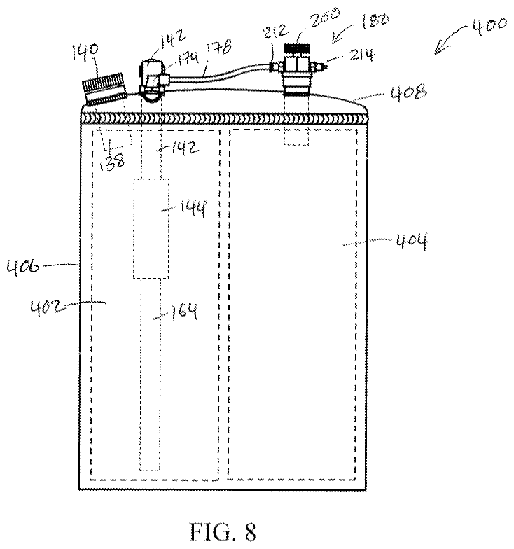

Certain additional example embodiments will now be described with reference to FIGS. 7-8. First, FIG. 7 is a schematic elevation view of a fire extinguisher 300 in accordance with an embodiment of the present invention. In this embodiment, fire extinguisher 300 is analogous in many respects to fire extinguisher 100 described above, and like reference numbers are used to denote like parts. As with fire extinguisher 100, fire extinguisher 300 also comprises two tanks with two interior volumes. However, in fire extinguisher 300, one of the tanks is disposed within (e.g., concentric with) the other tank.

More particularly, fire extinguisher 300 comprises a tank 302 defining a cylindrical body portion 304 to which a dome-shaped upper portion 306 is attached. Tank 302 is configured to store compressed gas in the same manner as tank 108 described above. Thus, tank 302 can be filled via Schrader valve 216 coupled with manifold 180. Manifold 108 is in fluid communication with an interior volume 308.

Fire extinguisher 300 also comprises a tank 310 that, in this embodiment, is disposed within or internal to tank 302. Tank 310, which is shown in broken lines in FIG. 7, is configured to store foam concentrate solution. Thus, tank 310 is coupled with fill opening 138 and fitting 142, and manifold 144 and tube 164 are disposed within tank 308. Tank 310 defines an internal volume 312 that can be filled with foam concentrate solution via fill opening 138 in the same manner as described above.

Fire extinguisher 300 operates in a manner analogous to the operation of fire extinguisher 100. However, in this embodiment, compressed gas surrounds the tank containing foam concentrate solution, at least in part. Thus, when nozzle 148 of fire extinguisher 300 is actuated, compressed gas will pass from interior volume 308 via manifold 180 into conduit 178, through fitting 174, and into interior volume 312. This will force foam concentrate solution into tube 164 and manifold 144, and compressed gas also will enter manifold 144. Foam 170 is again generated and forced through fitting 142, into conduit 146, and out of nozzle 148.

FIG. 8 depicts a fire extinguisher 400 in accordance with another embodiment of the present invention. Fire extinguisher 400 is analogous in many respects to fire extinguisher 100, described above, and again like reference numbers are used to denote like parts. Here, however, instead of separate tanks 106, 108 connected by a tank frame 102, fire extinguisher 400 comprises tanks 402 and 404, both of which are disposed within an outer housing 406. Tanks 402 and 404 preferably are analogous in function to tanks 106 and 108, and thus tank 402 stores foam concentrate solution and tank 404 stores compressed gas in the same manner described above, except that the plumbing connections (e.g., fill opening 138, fittings 142 and 174, manifold 180, and conduit 178) are coupled with an upper surface 408 of housing 406 and extend into housing 406 before connecting with tanks 402 and 404, as shown. In other embodiments, these plumbing connections could be disposed internal to housing 406. Although as shown housing 406 may itself be a tank in one embodiment, any suitable housing may be provided, and housing 406 may be formed of any suitable high-strength, low weight material, such as aluminum, stainless steel, or high-strength plastic. In some embodiments, housing 406 may be vented and/or may define one or more openings. Similarly, tanks 402 and 404 may be identical to tanks 106 and 108 described above in some embodiments, but tanks 402 and 404 also can be or comprise any suitable pressure vessel in other embodiments. As will be appreciated, fire extinguisher 400 operates in the same manner as fire extinguisher 100.

In both of the embodiments shown in FIGS. 7-8, a tank frame is not shown. Those of skill in the art will appreciate that a suitable tank frame can be provided in some embodiments. These embodiments also could be carried in a backpack, bag, or via another suitable method.

Based on the foregoing, it will be appreciated that embodiments of the invention provide improved fire extinguishers and methods of operating a fire extinguisher. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A fire extinguisher, comprising:
a first tank defining a first interior volume containing a foam concentrate solution;
a second tank coupled with the first tank, the second tank defining a second interior volume separate from the first interior volume, the second interior volume containing compressed air;
a first manifold disposed inside the first tank, the first manifold defining a first cavity, the first cavity having at least one opening for receiving the compressed air and at least one opening for receiving the foam concentrate solution;
a second manifold coupled with the second tank, the second manifold defining a second cavity in fluid communication with the second interior volume;
a Schrader valve coupled with the second manifold and selectively actuatable to introduce compressed air into the second cavity and the second interior volume;
a first conduit extending between the first tank and the second manifold of the second tank, the first conduit providing fluid communication between the first interior volume and the second interior volume;
a second conduit in fluid communication with the first interior volume and a nozzle, the nozzle selectively actuatable to discharge a foam formed from compressed air and foam concentrate solution passing through the first cavity of the first manifold.

2. The fire extinguisher of claim 1, wherein the first tank and the second tank each are welded to a frame.

3. The fire extinguisher of claim 2, wherein the first and second tanks are formed from aluminum.

4. The fire extinguisher of claim 1, further comprising a pressure relief valve coupled with the second manifold.

5. The fire extinguisher of claim 1, wherein the first and second conduits each comprise a rubber hose.

6. The fire extinguisher of claim 1, wherein the first conduit is in fluid communication with the second manifold via a one-way check valve.

7. The fire extinguisher of claim 1, wherein the first interior volume and the second interior volume are each about 3 gallons.

8. A method of operating a fire extinguisher, the method comprising:
providing a fire extinguisher comprising a tank assembly, the tank assembly defining a first interior volume and a second interior volume, the tank assembly further comprising:
a first manifold disposed within the first interior volume, the first manifold defining a first cavity, the first cavity defining a plurality of openings to the first interior volume;
a Schrader valve in fluid communication with the second interior volume;
a first conduit having a first end and a second end, the first end of the conduit in fluid communication with the first interior volume and the second end of the conduit in fluid communication with the second interior volume; and
a nozzle in fluid communication with the first interior volume via a second conduit;
filling the first interior volume with a foam concentrate solution;
filling the second interior volume with compressed air via the Schrader valve to a pressure between about 100 PSI and 150 PSI; and
actuating the nozzle to dispense a foam formed by the foam concentrate solution and the compressed air.

9. The method of claim 8, wherein the first interior volume and the second interior volume are the same size.

10. The method of claim 8, wherein actuation of the nozzle causes foam concentrate solution and compressed air to enter the first cavity and generate the foam, wherein the foam then enters the second conduit and is discharged from the nozzle.

11. The method of claim 8, further comprising exhausting the foam concentrate solution in the first interior volume without refilling the second interior volume with compressed air.

12. The method of claim 8, wherein the first interior volume is defined in a first tank, wherein the second interior volume is defined in a second tank separate from the first tank, and wherein the first and second tanks are fixed together.

13. The method of claim 8, further comprising filling the entirety of the first interior volume with foam concentrate solution.

14. A fire extinguisher comprising:
a frame, a first tank welded to the frame, and a second tank welded to the frame;
wherein the first tank contains foam concentrate solution and wherein the second tank contains compressed air;
a first manifold disposed inside the first tank, the first manifold defining a first cavity through which foam concentrate solution and compressed air pass in response to actuation of a nozzle that is in fluid communication with the first tank;
a second manifold coupled with the second tank, the second manifold comprising:
a housing defining a second cavity in fluid communication with an interior volume of the second tank, the second cavity further comprising a first port, a second port, and a third port;
a first valve in fluid communication with the first port, the first valve comprising:
a seat disposed in the second cavity;
a moveable valve stem; and
a valve member disposed in the second cavity and selectively engageable with the seat in response to movement of the valve stem;
a second valve in fluid communication with the second port; and
a third valve in fluid communication with the third port.

15. The fire extinguisher of claim 14, wherein the valve member comprises a ball.

16. The fire extinguisher of claim 14, wherein the second valve is a Schrader valve and the third valve is a one-way check valve.

17. The fire extinguisher of claim 16, further comprising a conduit extending between the first tank and the third valve.

18. The fire extinguisher of claim 14, wherein the second manifold further comprises a pressure relief valve in fluid communication with a fourth port.

19. The fire extinguisher of claim 18, wherein the second manifold further comprises a pressure gauge in fluid communication with a fifth port.

20. The fire extinguisher of claim 14, wherein the valve stem is moveable in response to rotation of a thumb screw.
